(19) United States
(12) Patent Application Publication
(10) Pub. No.: US 2020/0195290 A1
(43) Pub. Date: Jun. 18, 2020

(54) Specific Absorption Rate (SAR) Back-Off

(71) Applicant: Microsoft Technology Licensing, LLC, Redmond, WA (US)

(72) Inventors: Charbel KHAWAND, Redmond, WA (US); Sean R. MERCER, Redmond, WA (US)

(73) Assignee: Microsoft Technology Licensing, LLC, Redmond, WA (US)

(21) Appl. No.: 16/282,938

(22) Filed: Feb. 22, 2019

Related U.S. Application Data
(60) Provisional application No. 62/779,207, filed on Dec. 13, 2018.

(51) Int. Cl. H04B 1/3827; H04W 52/42; H04W 52/28

(52) U.S. Cl. CPC H04B 1/3838; H04W 52/283; H04W 52/42

(57) ABSTRACT

The claimed subject matter includes techniques for performing power reduction for specific absorption rate (SAR) compliance. An example method includes receiving sensor inputs indicative of potential for non-compliance with SAR limits at a mobile device. The example method includes processing the sensor inputs to generate a SAR action table index. A look-up is performed in a SAR action table using the SAR action table index to obtain SAR data. The SAR data identifies SAR actions to be performed individually for each antenna of each wireless endpoint of the mobile computing device based on the plurality of sensor inputs. The SAR data may be sent to each of the wireless endpoints. Each of the wireless endpoints is to select an amount of power reduction to implement for each of the antennas associated with the wireless endpoint to maintain SAR compliance in response to the SAR data.

### CROSS-REFERENCE TO RELATED APPLICATIONS

This application claims the benefit of U.S. Patent Provisional Patent Application Ser. No. 62/779,207, filed Dec. 13, 2018, and entitled “Specific Absorption Rate (SAR) Back-Off”, the application of which is incorporated herein in its entirety by reference.

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, and so on. Modern mobile computing devices may incorporate multiple antennas to support various wireless subsystems and communications. The multiple antennas may include for example one or more cellular, Wi-Fi, Bluetooth, global navigation satellite system (GNSS), and/or near field communication (NFC) antennas.

One challenge faced by mobile computing device designers is adherence to regulatory requirements that are imposed by entities such as the Federal Communication Commission (FCC), the European Union (EU), and so forth. An example of such regulatory requirements is legal limits on Specific Absorption Rate (SAR) that are established in relation to radio frequency (RF) energy associated with the various wireless and communications subsystems of a mobile computing device. Achieving compliance with SAR limits involves reducing the RF transmit power for communication hardware (e.g., radios) to a power level that maintains legal compliance in the presence of a user.

### SUMMARY

The following presents a simplified summary of the innovation in order to provide a basic understanding of some aspects described herein. This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

An embodiment provides a method for performing power reduction for SAR compliance in a computing device. An example method includes receiving a plurality of sensor inputs indicative of potential for non-compliance with specific absorption rate (SAR) limits at a mobile computing device. The example method also includes processing the plurality of sensor inputs to generate a SAR action table index. The example method also includes performing a look-up in a SAR action table using the SAR action table index to obtain SAR data. The SAR data identifies SAR actions to be performed individually for each antenna of each wireless endpoint of the mobile computing device based on the plurality of sensor inputs. The example method also includes sending the SAR data to each of the wireless endpoints. Each of the wireless endpoints is to select an amount of power reduction to implement for each of the antennas associated with the wireless endpoint to maintain SAR compliance in response to the SAR data. Other embodiments include a computing device and one or more non-transitory computer readable media to perform the method. The embodiments described herein provide SAR management at a per-antenna granularity.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of an example system for SAR back-off management according to implementations described herein;

FIGS. 2-5 are process flow diagrams summarizing methods of ensuring proper operation of the SAR framework according to implementations described herein;

FIG. 6 is a block diagram of an exemplary computing device configured for implementing various aspects of the techniques described herein.

### DETAILED DESCRIPTION

One challenge faced by mobile computing device designers is adherence to Specific Absorption Rate (SAR) limits that are established in relation to radio frequency (RF) emissions by mobile devices. The reduction of the RF transmit power for SAR compliance may be referred to herein as SAR back-off.

In traditional SAR back-off techniques, any proximity nearing any of the MIMO antennas will trigger a global back off for all antennas, reducing the RF transmit power across all communication hardware. In some cases, a certain back off can be very harsh as mandated by a FCC test of the product. In the case of a 4×4 (Multiple Input/Multiple Output (MIMO) system, such a trigger near one antenna must be applied to all four equivalently. This leads to a degradation of signal integrity and to a possible drop of signal connection with the cellular base station or Access Point (AP). The present disclosure describes a global and adaptive software framework that can be deployed to map the proximity trigger points and other sensor data and stimulus to multiple pre-configured and/or programmable back off actions. The outcome guarantees FCC safety while improving communication performance.

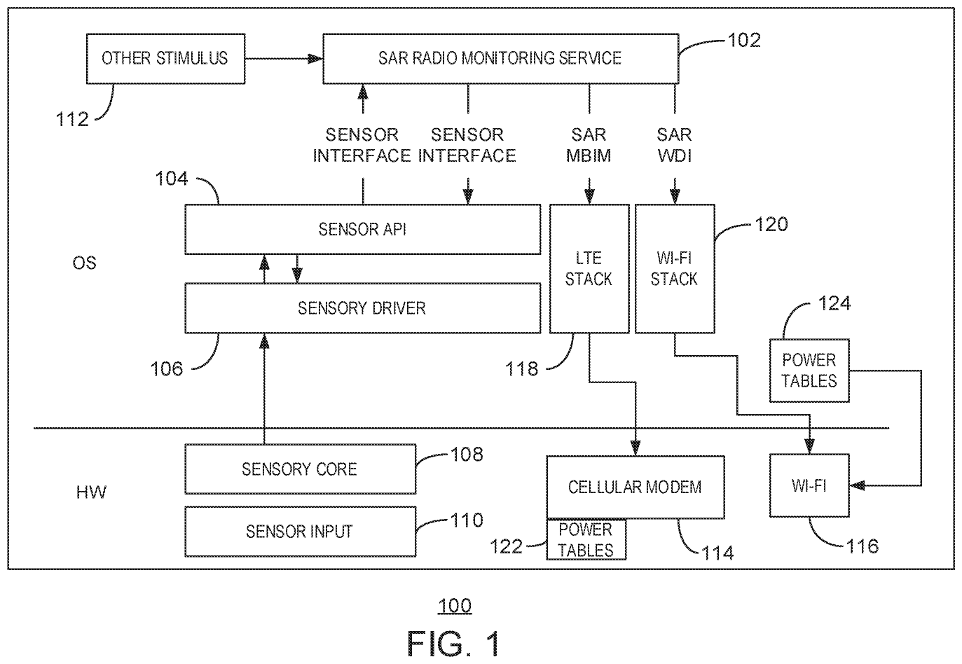

The framework consists of a SAR manager and a SAR action table. The SAR action table may be pre-programmed and stored in a secure zone in the device memory, such as the device's Basic Input Output System (BIOS), or Unified Extensible Firmware Interface (UEFI) system partition. The new approach to SAR back-off described herein provides granularity across modem vendors, technologies, and individual antennas and lessens the transmit power reduction depending on sensor triggers. This is a simple approach to a complicated SAR management as more antennas and technologies affect each other due to their numbers and proximity to each other. The SAR manager is described in relation to FIG. 1.

FIG. 1 is a block diagram of an example system for SAR back-off management according to implementations described herein. The example computer system 100 shown in FIG. 1 includes a SAR radio monitoring service 102 that receives sensor inputs and other stimulus that are used to determine the SAR configuration, i.e., the particular back-off actions that may be needed. Sensor inputs may be received from a sensor Application Programming Interface (API) 104, which is in communication with a sensor driver 106. The sensor driver 106 receives sensor data from a sensor core 108, which receives sensor input from variety of sources of sensor input 110. The sources of sensor input 110 may include proximity sensors for detecting the proximity of a user, accelerometer data, sensors for determining the angle of the device's keyboard, and others. The sensor data include data about the triggering of proximity sensors, the posture and angle of the device, and others. Other stimulus 112 may also be received from the device such as the geographical location of the device, and others.

The sensor data and other stimulus is received by the SAR radio monitoring service 102, which determines the appropriate back-off configuration and sends signals to the wireless communication systems, also referred to as wireless endpoints. The wireless communication systems implement the requested back-off configuration in accordance with the received signals. The SAR radio monitoring service 102 may collect and coalesce the sensor data periodically based on a programmable or dynamic hysteresis value that determines how often to react to sensor changes.

Control of the communication systems may be implemented through software stacks, which control the radio communications hardware. For example, the example system of FIG. 1 includes two wireless endpoints, including a cellular modem 114 and WiFi modem 116. As shown in FIG. 1, the operating system of the computer system 100 includes an LTE software stack 118 that drives the cellular modem 114, and a WiFi software stack 120 that drives the WiFi modem 116. The SAR data may be communicated to these wireless endpoints through their respective software stacks. For illustration, the present disclosure describes a device with two communication technologies, LTE and WiFi. However, it will be appreciated that the disclosed techniques can be applied to any number and type of wireless communication systems, including 3G, 4G, and 5G cellular, Wi-Fi, global navigation satellite system (GNSS), Near Field Communication (NFC), Bluetooth, and others.

The signals sent from the SAR radio monitoring service may include indices to power reduction tables 122 and 124 (also referred to herein as “low power tables”) that specifies the power reduction to be implemented based on the frequency of operation in the event that SAR back-off is triggered. The power reduction tables 122 and 124 may be pre-defined and stored to a memory device of each individual RF hardware module, as shown, for example, in relation to the cellular modem. In some examples, the power reduction tables may also be stored on the computing device and readable by the RF hardware module, as shown, for example, in relation to the WiFi hardware. The generation of the back-off signals is described further in relation to Tables 1-3.

TABLE 1
SAR Trigger Type Table

| | ENUM | |
|---|---|---|
| SAR STATES | VALUE | DESCRIPTION |
| DEVICE_IN_MOTION | 1 | This state overrides all other conditions and removes any |
| | | power back off from both modem and Wi-Fi |
| CLOSED_ANGLE_PEEK_0_60 | 2 | The device is in this state when it is at an angle between 0 |
| | | and 60 degrees |
| READ_COMPOSE_TENT | 3 | The device is in this state when it is at an angle between |
| | | 60 and 170 degrees or 190 and 355 degrees. |
| FLAT_ANGLE | 4 | The device is in this state when it is at an angle between |
| | | 170 and 190 degrees |
| FLIP_ANGLE_355_360 | 5 | The device is in this state when it is at an angle between |
| | | 355 and 360 degrees |
| SMILTANEOUS_TX | 6 | The device is in a state where both Wi-Fi and LTE are |
| | | enabled by the OS for simultaneous transmission |
| EARPIECE | 7 | The earpiece is enabled |
| INVALID_SENSOR_STATE | 8 | The sensor state is nable to determine an accurate |
| | | position |

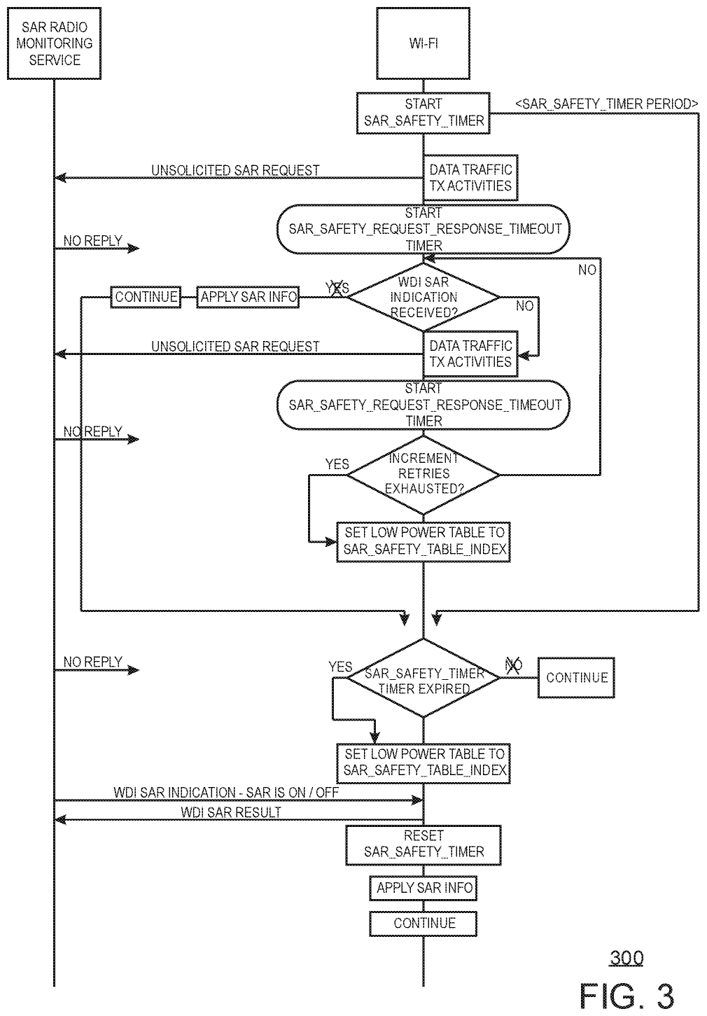

Table 3 summarizes the SAR states as enumeration values, referred to in the SAR framework as “Trigger Types.” The trigger types correspond with the sensor inputs or other SAR relevant stimulus received by the SAR radio monitoring service. It will be appreciated that the trigger types shown on FIG. 3 are merely examples, and that more or less trigger types may be defined and used based on the design details of a particular implementation. For example, trigger types may be used that correspond with specific proximity sensors. Additionally, some trigger types may correspond with the orientation of the device, such as whether the device is lying flat on a level surface, or is in landscape or portrait orientation. The trigger types are coalesced to form “Trigger Indexes,” as described further in relation to Table 2.

TABLE 2
SAR index table

| HASHED | | | | | | | | |
|---|---|---|---|---|---|---|---|---|
| TRIGGER | ENUM | ENUM | ENUM | ENUM | ENUM | ENUM | ENUM | ENUM |
| INDEX | VALUE | VALUE | VALUE | VALUE | VALUE | VALUE | VALUE | VALUE |
| VALUE | 1 | 2 | 3 | 4 | 5 | 6 | 7 | 8 |
| 0 | N | Any | Any | Any | Any | Any | Any | Any |
| | | State | State | State | State | State | State | State |
| 1 | Y | Y | Any | Any | Any | Any | Any | N |
| | | | State | State | State | State | State | |
| 2 | Y | N | Y | N | N | N | N | N |
| 3 | Y | N | Y | N | N | Y | N | N |
| 4 | Y | N | N | Y | N | N | N | N |
| 5 | Y | N | N | Y | N | Y | N | N |
| 6 | Y | N | N | N | Y | N | Y | N |
| 7 | Y | N | N | N | Y | N | N | N |
| 8 | Y | N | N | N | N | N | N | Y |
| 9 | Y | N | N | N | N | N | Y | Y |
| 10 | Y | N | N | N | N | Y | N | Y |
| <EOT> | <EOT> | <EOT> | <EOT> | <EOT> | <EOT> | <EOT> | <EOT> | |

The SAR index table (Table 2) is used to coalesce the activated trigger types into a trigger index value. The enum values corresponding with the trigger types are shown across the top row of the table. The resulting trigger index value is shown in the leftmost column. The table entries determine whether the particular trigger type associated with the enum value has been triggered. The “Y” indicates that the trigger type has been triggered, “N” indicates that the trigger type has not been triggered, and “Any State” indicates that the enum value is irrelevant for generating the indicated trigger index value. These trigger indexes will form index entries into the SAR Action Table (Table 3) where actual decisions for transmitting back-off instructions are generated. Given the amount of triggers to be handled, the SAR index table may not use all possible combinatory values. Instead the SAR index table may represent only a hashed value that describes the final coalesced state that is used to determine SAR configuration based on the sensor input and other stimulus. The SAR index table may be stored to a memory on the device, such as the device's BIOS or EUFI, and may be programmed according to the design considerations for a specific type of device. Additionally, in some examples, each individual antenna or wireless endpoint can be associated with a separate SAR index table. In this way, a different SAR index may be obtained for each antenna or each wireless endpoint depending on the sensor inputs or other SAR relevant stimulus.

TABLE 3
SAR Action Table

| Hashed | | | | Low | | | | |
|---|---|---|---|---|---|---|---|---|
| Trigger | | | | Power | | | | |
| Index | Ant 1 | Ant 2 | | Table | AnT 1 | Ant 2 | | Table |
| Value | LTE | LTE | MIMO | Index | WiFi | WiFi | MIMO | Index |
| 0 | SAR OFF | SAR OFF | N/A | N/A | SAR OFF | SAR OFF | 2x2 | N/A |
| 1 | SAR ON | SAR ON | N/A | 1 | SAR OFF | SAR OFF | 2x2 | N/A |
| 2 | SAR ON | SAR ON | N/A | 1 | SAR OFF | SAR OFF | 2x2 | N/A |
| 3 | SAR ON | SAR ON | N/A | 1 | SAR ON | SAR ON | 2x2 | 1 |
| 4 | SAR ON | SAR ON | N/A | 2 | SAR ON | SAR ON | 2x2 | 1 |
| 5 | SAR ON | SAR ON | N/A | 2 | SAR ON | SAR ON | 2x2 | 2 |
| 6 | SAR OFF | SAR OFF | N/A | N/A | SAR ON | SAR ON | 2x2 | 1 |
| 7 | SAR ON | SAR ON | N/A | 1 | SAR OFF | SAR OFF | 2x2 | N/A |
| 8 | SAR ON | SAR ON | N/A | 2 | SAR ON | SAR ON | 2x2 | 1 |
| 9 | SAR OFF | SAR OFF | N/A | N/A | SAR ON | SAR ON | 2x2 | 1 |
| 10 | SAR ON | SAR ON | N/A | 2 | SAR ON | SAR ON | 2x2 | 2 |
| <EOT> | <EOT> | <EOT> | <EOT> | <EOT> | <EOT> | <EOT> | <EOT> | <EOT> |

The SAR action table (Table 3) is used to generate the SAR instructions that are sent to the wireless communication hardware. The structure of the table is a linked header that informs the SAR manager what modem technologies are being managed. For illustration, the present disclosure describes a device with 2 LTE and 2 WiFi antennas, referred to as Ant 1 LTE, Ant 2 LTE, Ant 1 WiFi, and Ant 2 WiFi. However, it will be appreciated that any number of additional antennas and wireless technologies may be added depending on the wireless communication hardware present in the device.

The header also tells the software how to parse the configuration table as it denotes the number of antennas that are to be managed for SAR compliance. This allows the table to dynamically change shape across products as more or less modems and antennas get added or deleted. The table brings a lot of flexibility to address back-off per antenna and not per technology while also providing a different back off option for each scenario. There is also the combination of sensor triggers across technologies that can also happen when the user triggers them.

The trigger index value indicated by the SAR index table is used to look up the back-off instructions, which are then sent by the SAR radio monitoring service to the wireless communication hardware, i.e., the wireless endpoints. The back-off instructions indicate whether back-off protection is indicated, and also identifies a low power table index to be sent to the wireless endpoints. The low power table index is used by the wireless endpoint as an input to a low power table that identifies the specific power reduction requirements to be implemented. The low power tables identify a power reduction level applicable for a range of frequencies. The wireless endpoints use the low power table index to look up the appropriate power reduction needed for the particular frequency or range of frequencies that the wireless endpoint is currently operating at. In some examples, the low power tables may be stored to the wireless endpoint hardware and programmed by the manufacturer of the wireless endpoint hardware. Although the SAR action table shown above provides a single low power table index for each modem technology, the SAR action table may also specify a different low power table index for each antenna individually.

As shown in the example SAR action table, the first trigger index value, index 0, is selected when the device is at rest—not moving. In this case, high power is allowed on both wireless endpoints, i.e., SAR back-off protection is not indicated. The following trigger index value, index 1, specifies the scenario where the device is moving, the device is opened slightly (up to 5 degrees), and simultaneous transmission is enabled on both LTE and Wi-Fi. In this case, LTE is selected to be in back-off mode using low power table index 1 and high power is allowed on the WiFi wireless endpoint.

To take full advantage of the low power table indexing, there may be an added level of abstraction that is part of the SAR framework service. To provision devices for use across countries, the use of non-proximity stimulus to manage SAR might or might not be the same. Accordingly, in some examples, distinct SAR action tables may be programmed for each region, or different low power tables may be programmed for each region. In these examples, the SAR radio monitoring service may subscribe to receive a region indicator, such as the Mobile Country Code (MCC) value, and based on that value select the appropriate SAR action table and/or the low power table mapping for that region.

In some example, the device is programmed with distinct SAR action tables per region. In this case, the SAR framework, e.g., the SAR radio monitoring service, subscribes to get the MCC or GEO alpha string. Once the value is known, it proceeds to get the proper SAR table through additional look up tables. Each SAR action table may be programmed with different low power table indexes that are applicable to provide the back-off power reduction appropriate for the indicated region. This process may be repeated if the device is provisioned for dynamic SAR across regions.

In some examples, the device is programmed with a single universal SAR action table that refers to multiple low power tables, wherein each low power table refers to a different region. In this embodiment, the MCC or GEO alpha string is used to identify the indicated power table and the low power table index received from the universal SAR action table is applied to the identified table. Thus, the low power table index in the SAR action table becomes an inferred index to the actual region table holding the low power tables that are of interest to that region.

SAR Static Tables

The following table shows various SAR related data that may be stored in a secure UEFI, or equivalent storage, represented as unsigned byte sequences. The tables are in UEFI as well as other SAR flags per subsystem (e.g., Wi-Fi may have one such block and the cellular modem may have another one—Note that for the cellular modem, the low power tables are not part of the structure). Also note, that WiFi end point hardware may hold the low power tables in its Block Data Format (BDF) file instead.

TABLE 4
SAR Related UEFI Variables

| Actual | | |
|---|---|---|
| Value | Value Name | Description |
| | Header_Size | Size of Header in Bytes - |
| | | inclusive |
| | Header | Indicates the start of SAR info |
| | Header | Indicates the start of SAR info |
| | Wi-Fi_Technology | Wi-Fi 802.11/ac, ad, WiGig, etc. |
| | Product_ID | Product Identification |
| | Version | SAR version |
| | Revision | SAR Revision |
| | Number of SAR tables | Total number of SAR tables |
| | SAR Tables Compressed Status | Flag to indicate that the tables |
| | | are stored in compressed mode |
| | SAR_Timers_Format | Indicates Endian types, ‘0’ is |
| | | Little Endian and ‘1’ is Big Endian |
| | Reserved | Reserved |
| | Reserved | Reserved |
| | Reserved | Reserved |
| | Reserved | Reserved |
| | Reserved | Reserved |
| | Reserved | Reserved |
| | UEFI_Flags_Size | Size of UEFI flags in Bytes - |
| | | inclusive |
| | SAR_SAFETY_TIMER | See Table 5 Description |
| | SAR_SAFETY_REQUEST_RESPONSE_TIMEOUT | See Table 5 Description |
| | SAR_UNSOLICITED_UPDATE_TIMER | See Table 5 Description |
| | SAR_STATE | See Table 5 Description |
| | SLEEP_MODE_STATE | See Table 5 Description |
| | SAR_POWER_ON_STATE | See Table 5 Description |
| | SAR_POWER_ON_STATE_AFTER_FAILURE | See Table 5 Description |
| | SAR_SAFETY_TABLE_INDEX | See Table 5 Description |
| | SLEEP_MODE_STATE_INDEX_TABLE | See Table 5 Description |
| | GEO_LOCATION_VALUE | See Table 5 Description |
| | GEO_COUNTRY_STRING | See Table 5 Description |
| | SAR_Tables_Size | Size of all SAR static tables in |
| | | Bytes - inclusive |
| TABLE | SAR_2412_2462_CCK | Value in 5.3 format, 0-31.875 |
| INDEX: | | dbm, 0.125 steps |
| 1 | SAR_2467_CCK | Value in 5.3 format, 0-31.875 |
| | | dbm, 0.125 steps |
| | SAR_2472_CCK | Value in 5.3 format, 0-31.875 |
| | | dbm, 0.125 steps |
| | SAR_2484_CCK | Value in 5.3 format, 0-31.875 |
| | | dbm, 0.125 steps |
| | SAR_2412_2462_LEGACY | Value in 5.3 format, 0-31.875 |
| | | dbm, 0.125 steps |
| | SAR_2467_CCK_LEGACY | Value in 5.3 format, 0-31.875 |
| | | dbm, 0.125 steps |
| | SAR_2472_CCK_LEGACY | Value in 5.3 format, 0-31.875 |
| | | dbm, 0.125 steps |
| | SAR_2484_CCK_LEGACY | Value in 5.3 format, 0-31.875 |
| | | dbm, 0.125 steps |
| | SAR_2412_2462_VHT40 | Value in 5.3 format, 0-31.875 |
| | | dbm, 0.125 steps |
| | SAR_5180-5240_LEGACY | Value in 5.3 format, 0-31.875 |
| | | dbm, 0.125 steps |
| | SAR_5260-5320_LEGACY | Value in 5.3 format, 0-31.875 |
| | | dbm, 0.125 steps |
| | SAR_5500-5560_LEGACY | Value in 5.3 format, 0-31.875 |
| | | dbm, 0.125 steps |
| | SAR_5580-5720_LEGACY | Value in 5.3 format, 0-31.875 |
| | | dbm, 0.125 steps |
| | SAR_5745-5825_LEGACY | Value in 5.3 format, 0-31.875 |
| | | dbm, 0.125 steps |
| | SAR_5180-5240_40 | Value in 5.3 format, 0-31.875 |
| | | dbm, 0.125 steps |
| | SAR_5260-5320_40 | Value in 5.3 format, 0-31.875 |
| | | dbm, 0.125 steps |
| | SAR_5500-5560_40 | Value in 5.3 format, 0-31.875 |
| | | dbm, 0.125 steps |
| | SAR_5580-5720_40 | Value in 5.3 format, 0-31.875 |
| | | dbm, 0.125 steps |
| | SAR_5745-5825_40 | Value in 5.3 format, 0-31.875 |
| | | dbm, 0.125 steps |
| | SAR_5180-5240_80 | Value in 5.3 format, 0-31.875 |
| | | dbm, 0.125 steps |
| | SAR_5260-5320_80 | Value in 5.3 format, 0-31.875 |
| | | dbm, 0.125 steps |
| | SAR_5500-5560_80 | Value in 5.3 format, 0-31.875 |
| | | dbm, 0.125 steps |
| | SAR_5580-5720_80 | Value in 5.3 format, 0-31.875 |
| | | dbm, 0.125 steps |
| | SAR_5745-5825_80 | Value in 5.3 format, 0-31.875 |
| | | dbm, 0.125 steps |
| | SAR_5180-5240_160 | Value in 5.3 format, 0-31.875 |
| | | dbm, 0.125 steps |
| | SAR_5260-5320_160 | Value in 5.3 format, 0-31.875 |
| | | dbm, 0.125 steps |
| | SAR_5500-5560_160 | Value in 5.3 format, 0-31.875 |
| | | dbm, 0.125 steps |
| | SAR_5580-5720_160 | Value in 5.3 format, 0-31.875 |
| | | dbm, 0.125 steps |
| | SAR_5745-5825_160 | Value in 5.3 format, 0-31.875 |
| | | dbm, 0.125 steps |
| | . . . | |
| TABLE | Last Indexed set of tables | |
| INDEX: | | |
| n | | |
| TABLE | SAR_2412_2462_CCK | Value in 5.3 format, 0-31.875 |
| INDEX: | | dbm, 0.125 steps |
| 1 + n | SAR_2467_CCK | Value in 5.3 format, 0-31.875 |
| | | dbm, 0.125 steps |
| | SAR_2472_CCK | Value in 5.3 format, 0-31.875 |
| | | dbm, 0.125 steps |
| | SAR_2484_CCK | Value in 5.3 format, 0-31.875 |
| | | dbm, 0.125 steps |
| | SAR_2412_2462_LEGACY | Value in 5.3 format, 0-31.875 |
| | | dbm, 0.125 steps |
| | SAR_2467_CCK_LEGACY | Value in 5.3 format, 0-31.875 |
| | | dbm, 0.125 steps |
| | SAR_2472_CCK_LEGACY | Value in 5.3 format, 0-31.875 |
| | | dbm, 0.125 steps |
| | SAR_2484_CCK_LEGACY | Value in 5.3 format, 0-31.875 |
| | | dbm, 0.125 steps |
| | SAR_2412_2462_VHT40 | Value in 5.3 format, 0-31.875 |
| | | dbm, 0.125 steps |
| | SAR_5180-5240_LEGACY | Value in 5.3 format, 0-31.875 |
| | | dbm, 0.125 steps |
| | SAR_5260-5320_LEGACY | Value in 5.3 format, 0-31.875 |
| | | dbm, 0.125 steps |
| | SAR_5500-5560_LEGACY | Value in 5.3 format, 0-31.875 |
| | | dbm, 0.125 steps |
| | SAR_5580-5720_LEGACY | Value in 5.3 format, 0-31.875 |
| | | dbm, 0.125 steps |
| | SAR_5745-5825_LEGACY | Value in 5.3 format, 0-31.875 |
| | | dbm, 0.125 steps |
| | SAR_5180-5240_40 | Value in 5.3 format, 0-31.875 |
| | | dbm, 0.125 steps |
| | SAR_5260-5320_40 | Value in 5.3 format, 0-31.875 |
| | | dbm, 0.125 steps |
| | SAR_5500-5560_40 | Value in 5.3 format, 0-31.875 |
| | | dbm, 0.125 steps |
| | SAR_5580-5720_40 | Value in 5.3 format, 0-31.875 |
| | | dbm, 0.125 steps |
| | SAR_5745-5825_40 | Value in 5.3 format, 0-31.875 |
| | | dbm, 0.125 steps |
| | SAR_5180-5240_80 | Value in 5.3 format, 0-31.875 |
| | | dbm, 0.125 steps |
| | SAR_5260-5320_80 | Value in 5.3 format, 0-31.875 |
| | | dbm, 0.125 steps |
| | SAR_5500-5560_80 | Value in 5.3 format, 0-31.875 |
| | | dbm, 0.125 steps |
| | SAR_5580-5720_80 | Value in 5.3 format, 0-31.875 |
| | | dbm, 0.125 steps |
| | SAR_5745-5825_80 | Value in 5.3 format, 0-31.875 |
| | | dbm, 0.125 steps |
| | SAR_5180-5240_160 | Value in 5.3 format, 0-31.875 |
| | | dbm, 0.125 steps |
| | SAR_5260-5320_160 | Value in 5.3 format, 0-31.875 |
| | | dbm, 0.125 steps |
| | SAR_5500-5560_160 | Value in 5.3 format, 0-31.875 |
| | | dbm, 0.125 steps |
| | SAR_5580-5720_160 | Value in 5.3 format, 0-31.875 |
| | | dbm, 0.125 steps |
| | SAR_5745-5825_160 | Value in 5.3 format, 0-31.875 |
| | | dbm, 0.125 steps |
| | . . . | |
| TABLE | Last Indexed set of tables | |
| INDEX: | | |
| n + n | | |

In the above table, the SAR tables refer to an example low power table for a wireless endpoint. Each table index refers to the low power table index obtained from the SAR action table. The first column of the low power table describes the frequency range, and the second column describes the power reduction value to be applied for the corresponding frequency range. The SAR related EUFI flags shown in the above table are described in table 5 below.

SAR Flags and SAR Safety Fall Back

In some examples, the SAR framework uses a variety of security checks to ensure that the SAR operations are not compromised in any way and are optimized for the overall system. For example, a SAR safety timer and other flow checks on the host and firmware side may be used to ensure proper operation of the SAR framework. Table 5 below describes examples of SAR flags that may be used in example processed for ensure proper operation of the SAR framework.

TABLE 5
SAR Related UEFI Flag Descriptions

| UEFI FLAGS | Description |
|---|---|
| TIMER | |
| SAR_SAFETY_TIMER | This flag holds a timer value that is used by the |
| | FW to timeout and fall back into SAR safety mode |
| | when an update has not reached the FW for a |
| | period exceeding this timer value. |
| | FLAG VALUE is represented as a 4-Byte timer |
| | value in units of milliseconds |
| | This timer is used by the FW & SAR service to start |
| | a SAR safety timer value. FW uses this value to go |
| | into SAR safety back off when the SAR service fails |
| | to send its periodic update to the FW within that |
| | timer period. SAR service uses a timer value less |
| | than SAR_SAFETY_TIMER to send unsolicited & |
| | periodic updates to the FW. |
| | FLAG VALUE is ‘0xFFFFFFFF’ |
| | A value of 0xFFFFFFFF will indicate that this timer |
| | is not used, and SAR safety reliance is on the |
| | device to send unsolicited TX indications to the |
| | SAR service. |
| SAR_SAFETY_REQUEST_RESPONSE_TIMEOUT | This flag holds a tinner value that is used by the |
| | FW and host to timeout and fall back into safety |
| | mode when a reply is not received after a SAR |
| | request has been made. |
| | FLAG VALUE is represented as a 4-Byte timer |
| | value in units of milliseconds |
| | This timer is used between SAR requests and |
| | responses to and from the FW. If a response is not |
| | received within this timer value after a request |
| | has been sent, then the originator of the request |
| | is expected to fall into low power tables after a |
| | set of retries. This value is usually much smaller |
| | than SAR_SAFETY_TIMER and should be ~20 |
| | seconds. |
| SAR_UNSOLICITED_UPDATE_TIMER | This flag holds a timer value that decides how |
| | long has it been since a SAR update has been |
| | received by the FW from the SAR service. This |
| | timer refreshes each time an update has been |
| | received. If a transmit is scheduled and this timer |
| | has expired, LE must send an unsolicited request |
| | before ‘user-data’ transmit activities start. If it |
| | fails to receive a response, it will retry until either |
| | it succeeds or fails and fall into safety back off. |
| | FLAG VALUE is represented as a 4-Byte timer |
| | value in units of milliseconds |
| | Before a data Transmit, the device checks to see if |
| | this timer has expired. If it has, then it must send |
| | an unsolicited SAR request to the SAR service. If |
| | this timer has not expired, then no need to send |
| | for a new update and transmit power will use the |
| | last power table. |
| | FLAG VALUE is ‘0xFFFFFFFF’ |
| | A value of 0xFFFFFFFF will indicate that this timer |
| | is not used, and no unsolicited TX indications are |
| | sent to the SAR service. |
| STATE | |
| SAR_STATE | This flag indicates to the FW whether to ignore |
| | SAR requests from the Host or act on them - This |
| | flag is used during development. |
| | FLAG VALUE is ‘0’ |
| | If the flag is set to ‘0’ then SAR indications are |
| | ignored, and FW always uses high power tables |
| | (no back off). |
| | FLAG VALUE is ‘1’ |
| | If the flag is set to ‘1 then FW uses low power |
| | tables when SAR back off requests are received. |
| SLEEP_MODE_STATE | This flag is used to decide in certain host sleep |
| | states which power table to use by the FW. |
| | FLAG VALUE is ‘0’ |
| | If this flag is set to ‘0’ then FW is expected to use |
| | high power tables (no Back off) when the host is |
| | in sleep states. |
| | FLAG VALUE is ‘1’ |
| | If this flag is set to ‘1’ then FW is expected to use |
| | low power tables when the host is in sleep states. |
| | The power table index to use is specified in |
| | SLEEP_MODE_STATE_INDEX_TABLE. |
| SAR_POWER_ON_STATE | This flag is used to decide which power table to |
| | use by the FW on power up. |
| | FLAG VALUE is ‘0’ |
| | If this flag is ‘0’, then FW assumes high power |
| | table on power up (No back off) until a new |
| | update from SAR radio monitoring service is |
| | received indicating a change |
| | FLAG VALUE is ‘1’ |
| | If this flag is ‘1’, then FW assumes low power |
| | table on power up - The index of the power table |
| | is picked up from the |
| | SLEEP_MODE_STATE_INDEX_TABLE |
| SAR_POWER_ON_STATE_AFTER_FAILURE | This flag is used to decide if the last SAR state |
| | before shutdown needs to be maintained on the |
| | next reboot. |
| | FLAG VALUE is ‘0’ |
| | If this flag is ‘0’, then FW assumes normal |
| | operations of SAR on power up regardless of the |
| | last SAR state before reboot. For instance, if we |
| | were in SAR safety back off last, we do not need |
| | to maintain that state on the next power up. |
| | FLAG VALUE is ‘1’ |
| | If this flag is T, then FW assumes that it needs to |
| | stay in SAR safety back off across reboots and |
| | until the SAR condition has changed. For instance, |
| | if we were in SAR safety back off last, we do need |
| | to maintain it on the next power up until the next |
| | SAR update. |
| TABLE INDEX | |
| SAR_SAFETY_TABLE_INDEX | This flag is used to decide which table index to use |
| | when SAR_SAFETY_TIMER expires. |
| | FLAG VALUE is ‘1’ to MAX, where MAX |
| | represents the total number of Low Power |
| | Tables |
| | This value indicates the low power table index |
| | that the FW is required to use when the |
| | SAR_SAFETY_TIMER expires, and no updates |
| | have been yet received. |
| | Value represents the low power table index from |
| | 1 to MAX, where MAX is product & IHV specific. |
| SLEEP_MODE_STATE_INDEX_TABLE | This flag is used to decide which table index to use |
| | on power up or in sleep states. |
| | FLAG VALUE is ‘1’ to MAX, where MAX |
| | represents the total number of Low Power |
| | Tables |
| | Value indicating which low power table to use |
| | when the SLEEP_MODE_STATE is set to ‘1’ or |
| | SAR_POWER_ON_STATE is set to ‘1’. |
| | Value represents the low power table index from |
| | 1 to Max, where Max is product & IHV specific. |
| REGION | |
| GEO_LOCATION_VALUE | This index follows the geo provisioning value of |
| | the device. E.g., US, ETSI, World, etc. If we are |
| | using dynamic geo then this field is set to |
| | 0xFFFFFFFF and ignored. |
| | FLAG VALUE is ‘0xFFFFFFFF’ |
| | A value of ‘0xFFFFFFFF’ indicates that the device is |
| | provisioned for dynamic geo. Otherwise this field |
| | holds a MCC value. |
| GEO_COUNTRY_STRING | This is a 2-character string representing a country |
| | code. |

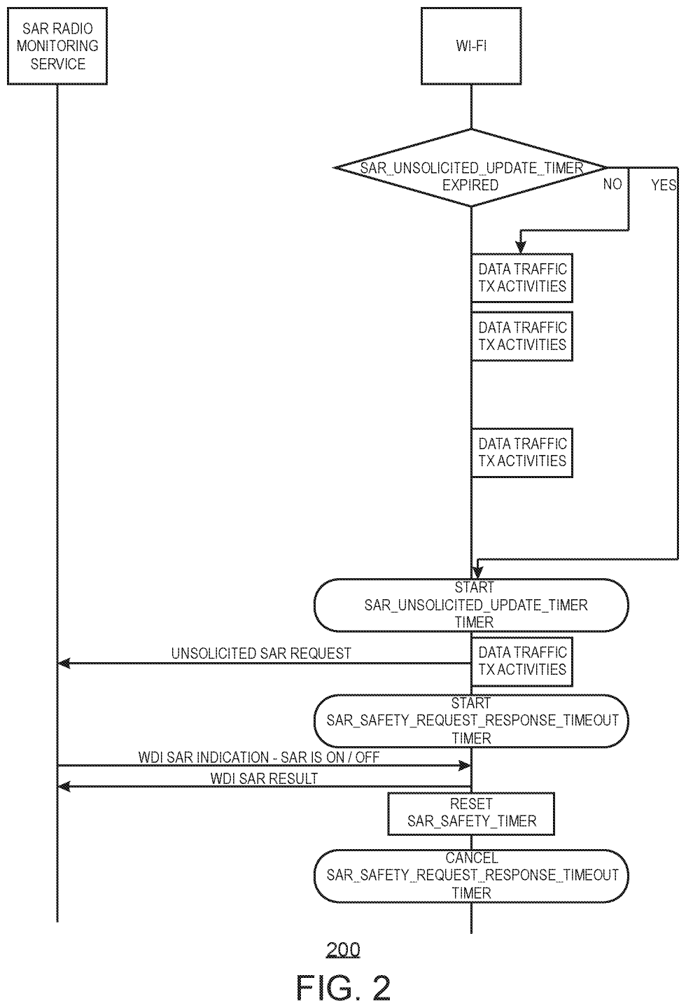

FIGS. 2-5 are process flow diagrams summarizing methods of ensuring proper operation of the SAR framework according to implementations described herein. One or more components of hardware or software of the computer systems 100 and 600 may be configured to perform the methods. The following flow diagrams are represented as simplified views to show core additional checks that may be performed for SAR safety. For illustration, the following processes are shown in relation to the WiFi communication interface. However, it will be appreciated that similar processed may be performed or all of the wireless communication interfaces included in the device.

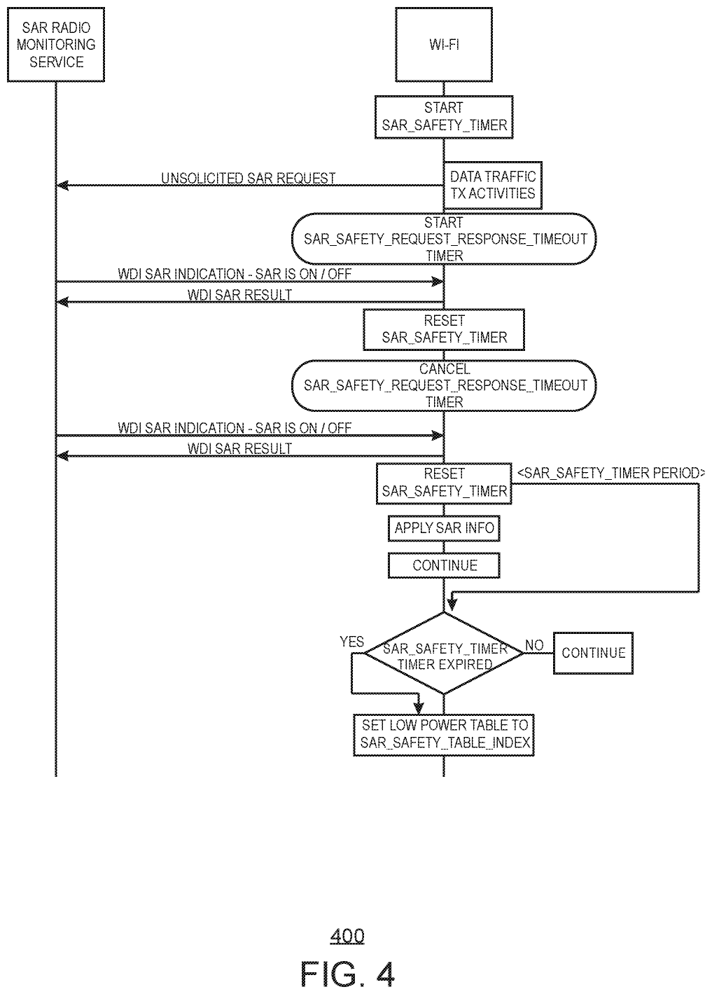

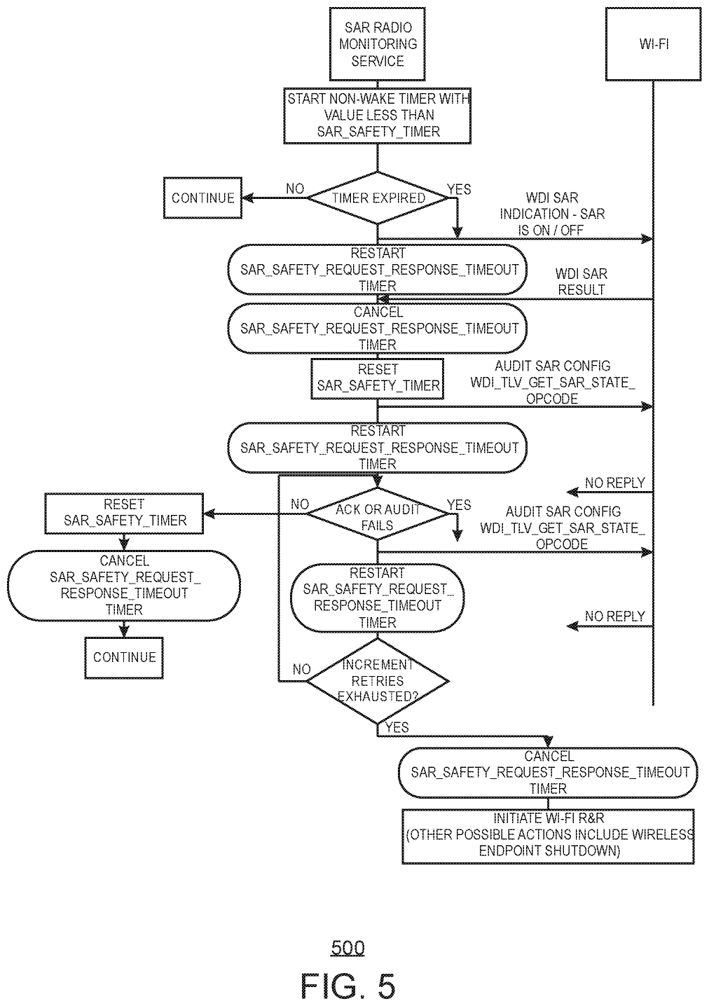

Upon SAR driver upload, unload, or disablement, the SAR radio monitoring service sends an unsolicited SAR update regardless of the SAR_SAFETY_TIMER expiry state. Additionally, the wireless endpoints may periodically send unsolicited SAR update requests to the SAR radio monitoring service. FIG. 2 shows a simplified process for processing unsolicited SAR update requests. FIG. 3 shows a simplified process for processing unsolicited SAR update requests in the case of SAR safety check failure. FIG. 4 shows a simplified process for processing unsolicited SAR update requests in the case of SAR safety check success. FIG. 5 shows a simplified process for processing unsolicited SAR updates from the SAR radio monitoring service in the case of SAR safety check failure. In the following process flow diagrams, the data traffic is any data buffer that is ready to be scheduled for transmission. Additional checks may be performed by the SAR radio monitoring service to ensure that the sensors are responsive and functional. If one or more sensors are determined to not be functional, then the SAR radio monitoring service may command one or more of the antennas or wireless endpoints to enter a back off mode until the condition is cleared.

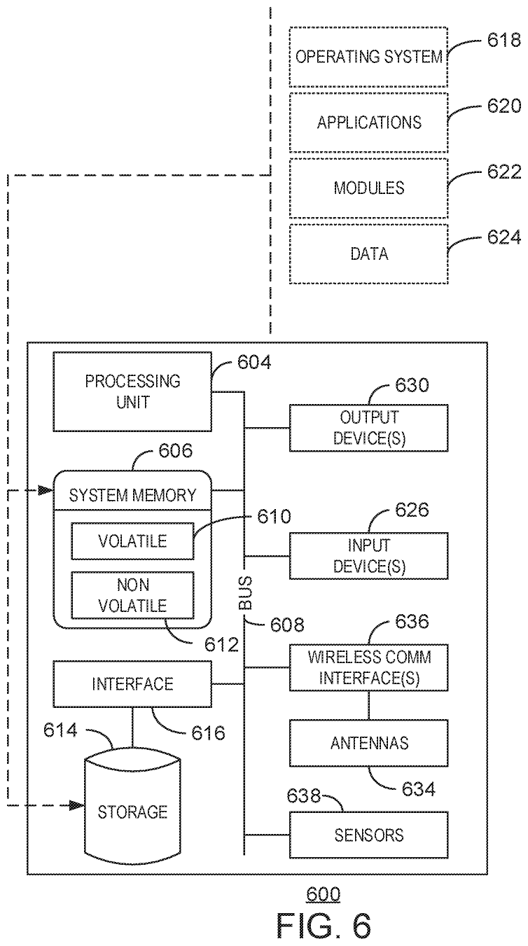

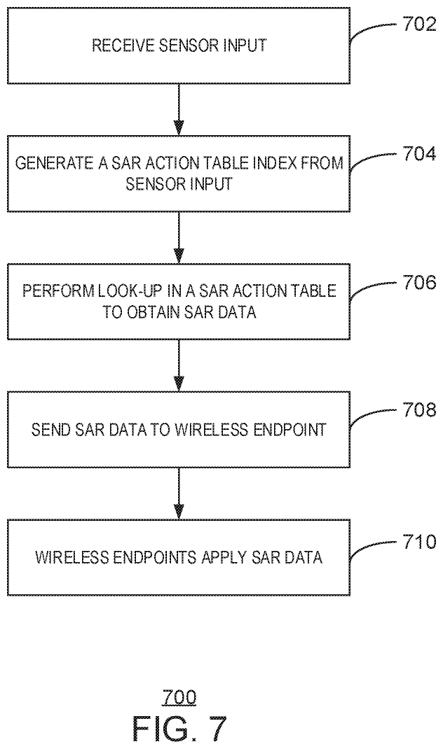

FIG. 6 is a block diagram of an exemplary computing device configured for implementing various aspects of the techniques described herein. FIG. 6 is intended to provide a brief, general description of a computing architecture in which the various techniques described herein may be implemented. For example, a method and system for performing power reduction management for SAR compliance can be implemented in such a computing environment. While the claimed subject matter has been described above in the general context of computer-executable instructions of a computer program that runs in the operating system environment and hardware of a computing device computer, the claimed subject matter also may be implemented in different combinations of program modules. Generally, program modules include routines, programs, components, data structures, or the like that perform particular tasks or implement particular abstract data types.

The computing device 600 is an example of a computing device that can be used to implement any of the techniques described above. For example, the exemplary computing device 600 may be a laptop computer, desktop computer, tablet computer, or smart phone, for example. The exemplary computing device 600 includes a processing unit 604, a system memory 606, and a system bus 608.

The system bus 608 couples system components including, but not limited to, the system memory 606 to the processing unit 604. The processing unit 604 can be any of various available processors. Dual microprocessors and other multiprocessor architectures also can be employed as the processing unit 604.

The system bus 608 can be any of several types of bus structure, including the memory bus or memory controller, a peripheral bus or external bus, and a local bus using any variety of available bus architectures known to those of ordinary skill in the art. The system memory 606 includes computer-readable storage media that includes volatile memory 610 and nonvolatile memory 612.

The BIOS or EUFI, containing the basic routines to transfer information between elements within the computing device 600, such as during start-up, is stored in nonvolatile memory 612. By way of illustration, and not limitation, nonvolatile memory 612 can include read only memory (ROM), programmable ROM (PROM), electrically programmable ROM (EPROM), electrically erasable programmable ROM (EEPROM), or flash memory.

Volatile memory 610 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computing device 600 also includes other computer-readable media, such as removable/non-removable, volatile/non-volatile computer storage media. FIG. 6 shows, for example a disk storage 614. Disk storage 614 includes, but is not limited to, devices like a magnetic disk drive, floppy disk drive, tape drive, Jaz drive, Zip drive, LS-210 drive, flash memory card, or memory stick.

In addition, disk storage 614 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 614 to the system bus 608, a removable or non-removable interface is typically used such as interface 616.

It is to be appreciated that FIG. 6 describes software that acts as an intermediary between users and the basic computer resources described in the suitable computing device 600. Such software includes an operating system 618. Operating system 618, which can be stored on disk storage 614, acts to control and allocate resources of the computing device 600.

System applications 620 take advantage of the management of resources by operating system 618 through program modules 622 and program data 624 stored either in system memory 606 or on disk storage 614. It is to be appreciated that the claimed subject matter can be implemented with various operating systems or combinations of operating systems.

A user enters commands or information into the computing device 600 through input devices 626. Input devices 626 include, but are not limited to, a pointing device, such as, a mouse, trackball, stylus, touch screens, a keyboard, a microphone, a joystick, a digital camera, a digital video camera, and the like. The computing device 600 also includes output devices 630, such as display screens, speakers, and others.

The computing device 600 also includes one or more wireless communication interfaces 636 corresponding with the wireless endpoints described above. The wireless communication interfaces 636 refers to the hardware and software employed to connect the wireless communication interfaces 636 to the bus 608. The wireless communication interfaces 636 can include one or a combination of WiFi interfaces, Bluetooth interfaces, NFC interfaces, and cellular interfaces such as 3G, 4G, 5G, and LTE, among others. Each of the wireless communication interfaces is coupled to one or more antennas for transmitting and receiving wireless signals.

The techniques described herein ensure that the power transmitted by these antennas adheres to any applicable SAR standards for the device. Accordingly, the computing device 600 may also include one or more sensors 638 for detecting the possible presence of human tissue. The sensor may be proximity sensors, including capacitive proximity sensors. The SAR radio monitoring service described in relation to FIG. 1 may be stored, for example, to the system memory 606 as part of the operating system 618. The SAR action tables (e.g., Table 3) and SAR index tables (e.g., Table 2) may be stored, for example, to the system memory 606 as a part of the BIOS of UEFI. The low power tables may be stored to a non-volatile memory device of the wireless communication interfaces 636 (i.e., wireless endpoints), and may also be stored to the system memory 606 to be read by the wireless communication interfaces 636 after the computing device 600 powers up. In some examples, one or more of the SAR compliance tables referred to above can be securely updated over a network so that the SAR compliance design can be updated after the computing device 600 has been shipped to a retailer or purchased by a consumer, for example.

FIG. 7 is a process flow diagram summarizing a method of performing power reduction for SAR compliance in a computing device. The computing device may be the computing device 600 described in reference to FIG. 6, for example. The process may be performed, at least in part, by the SAR radio monitoring service described in relation to FIG. 1. The process may begin at block 702.

At block 702, sensor inputs are received. The sensor input may be received from various sources and may be any data useful for identifying non-compliance with specific absorption rate (SAR) limits at the computing device. For examples, sensor input may be received from proximity sensors, accelerometer data for sensing the orientation of movement of the computing device, sensors for determining the angle of the device's keyboard, and others.

At block 704, a SAR action table index is generated based on the sensor inputs. For example, the SAR action table index may be generated by performing a look-up in a SAR index table that returns the SAR action table index corresponding to the plurality of sensor input. The SAR index table may be pre-programmed to provide a specific SAR action table index for different combinations of the sensor inputs, as described above.

At block 706, SAR data is obtained by performing a look-up in a SAR action table using the SAR action table index. The SAR data identifies the SAR actions to be performed individually for each antenna of each wireless endpoint of the mobile computing device based on the sensor inputs. As shown above, the SAR action table is structured to identify the wireless endpoints and identify the antennas associated with each wireless endpoint. Accordingly, the SAR action table may be customized to fit the design of a particular computing device without changing the basic SAR radio management process that is performed.

In some embodiments, the computing device may include different SAR action tables for different geographic regions. This allows the power reduction to be customized to adhere to the regulations applicable in different regions. In such embodiments, the process may include receiving a region indicator that identifies a geographic region in which the computing device is operating, selecting the SAR action table corresponding to the identified geographic region, and performing the look-up on the identified SAR action table.

At block 708, the retrieved SAR data is sent to each of the applicable wireless endpoints. The SAR data may take various forms in various embodiments. For example, the SAR data may include an indication of whether SAR back-off is to be applied and may also include a low power table index. The SAR data may identify SAR back-off actions to be performed at a wireless endpoint granularity or an individual antenna granularity. In other word, the SAR data may specify back-off actions to be performed for each wireless endpoint individually or for each antenna of each wireless endpoint individually. In some embodiments, the SAR data may also include a geographical indicator. This allows the wireless endpoints customize the level of power reduction to be applied depending on the geographic region.

At block 710, each of the wireless endpoints is to select an amount of power reduction to implement for each of the antennas associated with the wireless endpoint to maintain SAR compliance in response to the SAR data. Each of the wireless endpoints may include a low power table that identifies a level of power reduction to be applied at the wireless endpoint according to the power table index received in the SAR data and the frequency at which the wireless endpoint is currently operating. The level of power reduction may be determined by performing a lookup in the low power table using the low power table index and the operating frequency. In some embodiments, the geographic indicator can be used to identify the low power table that applicable for the corresponding region. In some embodiments, the low power tables are stored to a non-volatile memory device of the wireless endpoints and populated by the manufacturer of the wireless endpoint. In some embodiments, the low power table is stored to a non-volatile memory device of the computing device and read from non-volatile memory device by the wireless endpoints, in which case the low power tables may be populated by the manufacturer of the computing device.

Some of the associated figures describe concepts in the context of one or more structural components, variously referred to as functionality, modules, features, elements, or the like. The various components shown in the figures can be implemented in any manner, such as software, hardware, firmware, or combinations thereof. In some implementations, various components reflect the use of corresponding components in an actual implementation. In other implementations, any single component illustrated in the figures may be implemented by a number of actual components. The depiction of any two or more separate components in the figures may reflect different functions performed by a single actual component. FIG. 6, discussed herein, provides details regarding one computing device that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, such as application specific integrated circuits (ASICs), or the like.

As to terminology, the phrase “configured to” encompasses any way that any kind of functionality can be constructed to perform an identified operation. The functionality can be configured to perform an operation using, for instance, software, hardware, firmware, or the like. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media include physical hardware devices, such as magnetic storage devices, hard disk, floppy disk, magnetic strips, optical disk, compact disk (CD), digital versatile disk (DVD), smart cards, flash memory devices, among others. In contrast, computer-readable media, i.e., not storage media, may include communication media such as transmission media for wireless signals and the like.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A method of performing power reduction for SAR compliance in a computing device, comprising:
receiving a plurality of sensor inputs indicative of potential for non-compliance with specific absorption rate (SAR) limits at a mobile computing device comprising a plurality of wireless endpoints, wherein the plurality of sensor inputs indicate a manner in which the user is handling or operating the mobile computing device;
processing the plurality of sensor inputs to generate a SAR action table index to be input to a SAR action table, wherein the SAR action table correlates the plurality of sensor inputs with a plurality of separate SAR back-off instructions to be performed individually for each antenna;
performing a look-up in the SAR action table using the SAR action table index to obtain the plurality of separate SAR back-off instructions; and
sending the plurality of separate SAR back-off instructions to the plurality of wireless endpoints, wherein the plurality of wireless endpoints are to implement the plurality of separate SAR back-off instructions individually for each of the corresponding antennas associated with the plurality of wireless endpoints to maintain SAR compliance in response to the sensor inputs.

2. The method of claim 1, wherein processing the plurality of sensor inputs to generate a SAR action table index comprises performing a lookup in a SAR index table that returns the SAR action table index corresponding to the plurality of sensor inputs.

3. The method of claim 1, wherein the SAR action table is structured to identify the plurality of wireless endpoints and identify the corresponding antennas associated with each of the plurality of wireless endpoints.

4. The method of claim 1, wherein the plurality of separate SAR back-off instructions comprise a low power table index, and wherein a wireless endpoint of the plurality of wireless endpoints comprises a low power table that identifies a level of power reduction to be applied at the wireless endpoint by performing a lookup in the low power table using the low power table index.

5. The method of claim 4, comprising sending a region indicator to the plurality of wireless endpoints, and, at each of the plurality of wireless endpoints, selecting the low power table corresponding to the region indicator from among a plurality of low power tables for different geographic regions.

6. The method of claim 1, comprising receiving a region indicator that identifies a geographic region in which the computing device is operating, and selecting the SAR action table corresponding to the identified geographic region from among a plurality of SAR action tables for different geographic regions.

7. A computing device with a specific absorption rate (SAR) compliance management system, the computing device comprising:
a wireless endpoint;
a non-volatile memory device comprising a SAR action table; and
one or more processing devices configured to provide a SAR radio monitoring service, the processing devices to:
receive a sensor input indicative of potential for non-compliance with SAR limits at the wireless endpoint, wherein the sensor input indicates a manner in which the user is handling or operating the mobile computing device;
process the sensor input to generate a SAR action table index to be input to a SAR action table, wherein the SAR action table correlates the sensor input with a plurality of separate SAR back-off instructions to be performed individually for each antenna;
perform a look-up in the SAR action table using the SAR action table index to obtain the plurality of separate SAR back-off instructions; and
send the plurality of separate SAR back-off instructions to the wireless endpoint, wherein the wireless endpoint is to implement the plurality of separate SAR back-off instructions individually for each corresponding antenna associated with the wireless endpoint to maintain SAR compliance in response to the sensor inputs.

8. The computing device of claim 7, wherein to process the sensor input to generate the SAR action table index comprises to perform a look-up in a SAR index table that returns the SAR action table index corresponding to the sensor input.

9. The computing device of claim 7, wherein the SAR action table is structured to identify the wireless endpoint and identify the corresponding antennas associated with the wireless endpoint.

10. The computing device of claim 7, wherein the plurality of separate SAR back-off instructions comprise a low power table index, and wherein the wireless endpoint comprises a low power table that identifies a level of power reduction to be applied at the wireless endpoint by performing a lookup in the low power table using the low power table index.

11. The computing device of claim 10, wherein the low power table is stored to a non-volatile memory device of the computing device and read from non-volatile memory device by the wireless endpoint.

12. The computing device of claim 10, wherein the processing devices are to send a region indicator to the wireless endpoint, and the wireless endpoint is to select the low power table corresponding to the region indicator from among a plurality of low power tables for different geographic regions.

13. The computing device of claim 7, wherein the processing devices are to receive a region indicator that identifies a geographic region in which the computing device is operating, and to select the SAR action table corresponding to the identified geographic region from among a plurality of SAR action tables for different geographic regions.

14. The computing device of claim 7, wherein the SAR action table is stored to a Unified Extensible Firmware Interface (UEFI) system partition of the computing device.

15. The computing device of claim 7, wherein the wireless endpoint is one of a plurality of wireless endpoints included in the computing device, wherein the plurality of wireless endpoints comprise of two or more of:
a cellular modem;
a WiFi modem;
a global navigation satellite system (GNSS);
Near Field Communication (NFC) device; and
a Bluetooth device.

16. A tangible, computer-readable storage medium comprising instructions that, in response to an execution by a processor, cause the processor to:
receive a sensor input indicative of potential for non-compliance with SAR limits at a wireless endpoint, wherein the sensor input indicates a manner in which the user is handling or operating the mobile computing device;
generate a SAR action table index based on the sensor input, wherein the SAR action table index is to be input to a SAR action table that correlates the sensor input with a plurality of separate SAR back-off instructions to be performed individually for each antenna;
perform a look-up in the SAR action table using the SAR action table index to obtain the plurality of separate SAR back-off instructions; and
send the plurality of separate SAR back-off instructions to the wireless endpoint, wherein the wireless endpoint is to implement the plurality of separate SAR back-off instructions individually for each corresponding antenna associated with the wireless endpoint to maintain SAR compliance in response to the sensor inputs.

17. The tangible, computer-readable storage medium of claim 16,
wherein to process the sensor input to generate the SAR action table index comprises to perform a look-up in a SAR index table that returns the SAR action table index corresponding to the sensor input.

18. The tangible, computer-readable storage medium of claim 16, wherein the plurality of separate SAR back-off instructions comprise a low power table index, and wherein the wireless endpoint comprises a low power table that identifies a level of power reduction to be applied at the wireless endpoint by performing a lookup in the low power table using the low power table index.

19. The tangible, computer-readable storage medium of claim 18, wherein the processor is to send a region indicator to the wireless endpoint, and the wireless endpoint is to select the low power table corresponding to the region indicator from among a plurality of low power tables for different geographic regions.

20. The tangible, computer-readable storage medium of claim 16, wherein the processor is to receive a region indicator that identifies a geographic region in which the computing device is operating, and to select the SAR action table corresponding to the identified geographic region from among a plurality of SAR action tables for different geographic regions.
